(19) United States
(12) Patent Application Publication
(10) Pub. No.: US 2007/0239525 A1
(43) Pub. Date: Oct. 11, 2007

(54) Method For Increasing Healthy-Lifestyle Behaviors Of Medical Patients And IIncreasing The Income Of The Physicians That Treat Them

(76) Inventor: Edward Barker, Mobile, AL (US)

Correspondence Address: WELSH & KATZ, LTD, 120 S RIVERSIDE PLAZA, 22ND FLOOR, CHICAGO, IL, 60606, US

(21) Appl. No.: 11/306,776

(22) Filed: Jan. 11, 2006

Related U.S. Application Data
(60) Provisional application No. 60/672,413, filed on Apr. 18, 2005.

(51) Int. Cl. G06Q 30/00; G06Q 10/00

(52) U.S. Cl. 705/14; 705/2

(57) ABSTRACT

A method is disclosed for placement of non-regulated health-related products in health-care provider space and for providing compensation to said health-care provider.

### FIELD OF THE INVENTION

This invention relates generally to a process and method for the promotion of healthy-lifestyle products in medical facilities—products not regulated by the Department of Health and Human Services, Office of the Inspector General (OIG). A mode of practicing an embodiment of an invention in accordance with the present disclosure encourages medical patients to adopt healthy-lifestyle behaviors; can be effective in causing medical patients to adopt healthy-lifestyle behaviors; and can result in a concomitant increases in the income of the doctors who participate in the promotion of the same healthy-lifestyle products. Such products in general are not subject to extensive governmental regulation applicable to other medical products, such as the anti-kickback law enforced by the OIG and the requirements and oversight of the Food and drug Administration.

### BACKGROUND OF THE INVENTION

A physician's office can be prime advertising space for health-related products. Pharmaceutical companies routinely provide physicians with posters, charts, displays, and the like for placement in physician offices, but physicians have generally receive no promotional consideration for this usage.

The pharmaceutical industry invests literally billions of dollars in advertising and promotion. Such companies pay a premium to advertise brand name and generic drugs in print, on television, and in other media.

Such promotional activity also extends to the physicians office. Many health care provider facilities sometimes display posters promoting the wares of pharmaceutical companies and encouraging patients to ask their doctors for additional information. Pharmaceutical companies also encourage health care providers to distribute samples of their wares. Such samples may sometimes be provided to the health-care provider at no costs. Pharmaceutical companies may also provide other promotional articles and equipment for use by health care providers in their facilities such as, for example, wall clocks, pens, pads, drinking mugs, etc.

Such promotional materials touting particular pharmaceutical products are examples of direct-to-consumer advertising by pharmaceutical companies. Such advertising is intended, in part, to promote preliminary self-diagnosis by patients. Such preliminary self-diagnosis may benefit patient-consumers by encouraging informed discussions with their health care provider regarding health-care concerns and treatment alternatives. Such promotional materials from food, vitamin, fitness, and supplement manufacturers—which are not in general subject to extensive governmental regulation such as by OIG—may nevertheless reinforce the admonitions of doctors to their patients that they, their patients, adopt a healthier lifestyle by the use of healthier foods, fitness activities, appropriate vitamins, and appropriate supplements.

Making available such direct-to-consumer promotional materials is of economic value, as shown by the fact that pharmaceutical companies pay large sums for such advertising in print and other media. In general, however, health-care providers are often prohibited from receiving compensation from, for example, pharmaceutical companies for displaying such direct-to-consumer promotional materials. Receiving such compensation may violate, for example, anti-kickback laws and the like administered by the Department of Health and Human Services. Accordingly, there exists a need for a method and system to allow health-care providers to realize the economic benefit of their availability as a communications channel for direct-to-consumer advertising; and which simultaneously reminds and reinforces physicians' admonitions to their patients that they eat healthier foods, engage in regular fitness activities, and consume appropriate vitamins, and supplements.

### BRIEF SUMMARY

In accordance with certain embodiments of the method and system of the present invention, it has been recognized that health-care providers can realize additional sources of income from providing direct-to-consumer advertising for unregulated products that may still be relevant to health care concerns. For example, dietary supplements are not in general subject to anti-kickback laws, and purveyors of such products may find the facilities of a health care provider an attractive venue for promotional materials. As another example, exercise and fitness equipment providers may also desire to avail themselves of such a channel.

Although products such as for example food and fitness products are not regulated by for example anti-kickback, they are important for overall health. The food and fitness industry, like the pharmaceutical industry, spends heavily for advertising in various media channels.

An embodiment of the present invention therefore includes the method of soliciting advertising from food and fitness manufacturers for placement in health care provider facilities.

Another mode of practicing an embodiment of the present invention is a system including advertising placement representatives, unregulated industry advertisers willing to provide promotional consideration, and health care professionals whose facilities can be used as a promotional channel in exchange for promotional consideration.

### BRIEF DESCRIPTION OF THE SEVERAL VIEWS OF THE DRAWINGS

FIG. 1 depicts the existing system, in which health care providers provide valuable advertising space but receive no compensation.

FIG. 2 depicts an embodiment of the invention in which health care providers receive fair compensation in return for providing valuable advertising space.

### DETAILED DESCRIPTION

Although physicians are often highly compensated professionals, there nonetheless exists a need currently to provide supplemental sources of income to health care providers. It is well known, for example, that costs of liability insurance for medical practice and health care professionals have increased precipitously in recent years. This increase has in some circumstances led to a crisis in health care, adversely affecting availability of health care services in certain locations. Many health care practitioners may have been compelled for economic reasons including the high cost of liability insurance to substantially curtail services offered. This crisis may be particularly acute in economically disadvantaged locations.

There exists a need for additional means for promotion of non-regulated products. There also exists a need among physicians for ways to derive additional revenue from permissible product placements. More generally, there exists an economic need for more efficient economic allocation of resources.

A healthy-lifestyle business produces, manufacturers, distributes, or sells a product that is not a regulated pharmaceutical or medical device, but which does contribute generally to overall health. A health care organization facility provides medical services to patients such as, for example, a hospital or a doctor's office. A health care organization can promote the healthy-lifestyle products of manufacturers, and this action can in turn provide financial benefits to the health-care organization. A promotional business facilitates communication between one or more health care organizations and one or more health-lifestyle businesses. In one embodiment, the promotional business can accomplish this facilitation through using a network of property management agents.

Health-fitness promotional materials comprise, for example, advertising and the like for products such as health clubs and exercise equipment. Health-food advertising comprises, for example, advertising and the like for products such as low fat, low cholesterol, low sodium, diabetic, dietetic, whole grain, and high-fiber foods. Health-supplement promotional materials comprises advertising and the like for products that are taken to promote health but are not considered regulated pharmaceuticals, such as calcium, zinc, and ginseng. Vitamin promotional materials comprise advertising and the like for vitamins such as vitamin C, B-complex vitamins, and the like.

Other, unregulated products may also benefit from advertising and promotion in the physician's office. For such unregulated products the physician can permissibly receive compensation for the product placement. Supplements, vitamins, and the like may regularly be prescribed or suggested by a health-care provider, but are not themselves considered medicines and are not subject to the same regulation.

Embodiments in accord with the present invention can offer several advantages over the prior art. An embodiment practiced in accord with the present invention may also have the advantage of bringing about substantial employment opportunities to deserving persons.

In one mode of practicing an embodiment of the present invention, a promotional placement enterprise will retain placement agents to procure promotional channels from health care professionals. Health care professionals will be compensated for the channels secured with revenues the promotional placement enterprise derives from the non-regulated industry.

Companies potentially interested in such placement services may include suppliers of healthy foods and the like. Other companies in industries potentially interested in such promotional placement services may include pharmacies and drugstores. Other companies potentially interested in such promotional placement services may include, for example, fitness clubs and gymnasiums. Other companies potentially interested in such placement services may include, for example, manufacturers of fitness equipment for consumers.

One mode of practicing the method and system of an embodiment in accord with the present invention may offer the advantage of providing supplemental income to support health care practice. This supplemental income can help health care providers defray high operating costs such as the cost of liability insurance. Defraying such costs in turn can benefit society by enhancing the availability of health care services.

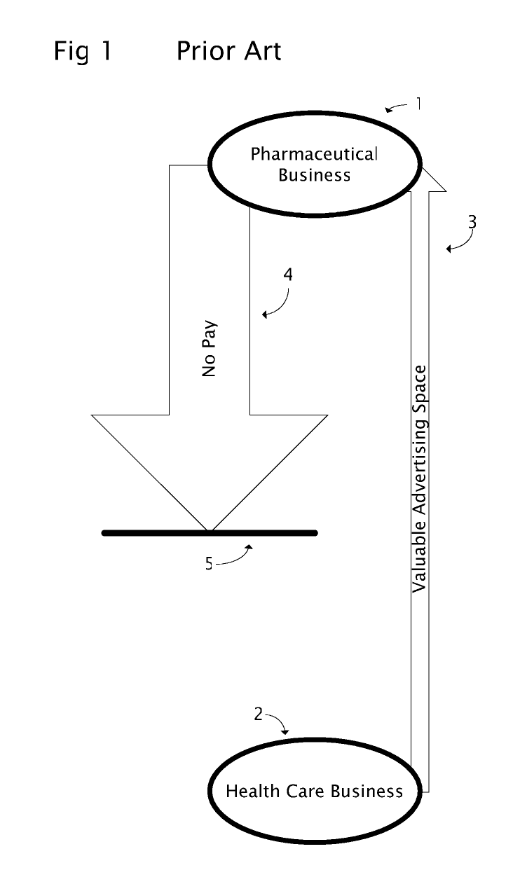

Referring now to FIG. 1, there is depicted the existing system, in which health care providers provide valuable advertising space but receive no compensation. Today, a health care business (2) provides valuable advertising space (3) to a pharmaceutical business (1). No payment (4) from the pharmaceutical business (1) goes to the health care business (2), however, due to regulatory prohibitions (5).

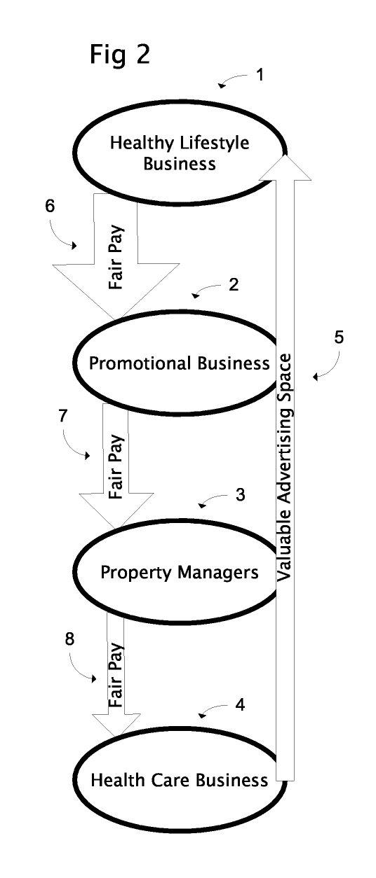

Referring now to FIG. 2, there is depicted an embodiment of one mode of practicing the invention in which health care providers receive fair compensation in return for providing valuable advertising space. A promotional business (2) and property managers (3) facilitate providing valuable advertising space from a health care business (4) to a healthy lifestyle business (5). In exchange, remuneration for promotional consideration flows to the promotional business (2), which is then shared with property managers (3) and the health care business (4). The promotional business remuneration (6) is then divided, to provide at least in part property manager remuneration (7) and health care business remuneration (8).

Promotional opportunities include in one embodiment space available for advertising such as, for example, wall space in the examining rooms of a health care provider. Promotional opportunities can also include, but are not limited to, branded products such as, for example, pens, note pads, key chains, flash lights, pocket knives, apparel,

Although particular embodiments of the invention are herein disclosed and described, it will be appreciated by those of ordinary skill in the art that the invention herein can be practiced in other particular modes and embodiments. Such alternative modes and embodiments are considered equivalent to the subject matter disclosed and claimed here. Such equivalents are intended to be encompassed in the scope of the claims below. The use of singular herein is intended to encompass the plural.

What is claimed is:

1. A system for promotion of healthy lifestyle products comprising:
A health care organization having a promotional channel,
A healthy lifestyle business seeking a promotional channel for promotion of a healthy lifestyle product, wherein said healthy lifestyle product is selected from the group consisting of health-fitness products, health-food products, and health-supplement products;
A promotional placement enterprise that receives payment from said healthy lifestyle business for providing the promotional channel;
A first promotional placement agent related to said promotional placement enterprise, said first promotional placement agent securing said promotional channel from said health care organization, said promotional placement enterprise paying said health care organization for said promotional channel, and said promotional placement agency paying said promotional placement agent for securing said promotional channel.

2. The system according to [claim 1], further comprising:
A second promotional placement agent recruited by said first promotional placement agent, wherein said promotional placement enterprise pays said first promotional placement agent for said second promotional placement agent securing a promotional channel.

3. A method of promoting healthy-lifestyle products by a promotional placement enterprise, said method comprising:
Obtaining a promotional opportunity from a healthy-lifestyle business, wherein said promotional opportunity is selected from the group consisting of health-fitness promotion, health-food promotion, and health-supplement supplement;
Recruiting a first promotional placement agent who secures a promotional channel from a health care organization;
Placing said promotional opportunity in said health care organization;
Receiving payment from said healthy-lifestyle business for said placement;
Paying said health care organization for said placement;
Paying said first promotional placement agent for said placement.

4. The method according to [claim 3], further comprising paying said first promotional placement agent for recruiting a second promotional placement agent.
